(19) United States
(12) Patent Application Publication
(10) Pub. No.: US 2015/0172604 A1
(43) Pub. Date: Jun. 18, 2015

(54) SYSTEM AND METHOD FOR AUTOMATICALLY SHIFTING TRACKING CONTROL AUTHORITY BETWEEN CAMERAS

(71) Applicant: Electronics and Telecommunications Research Institute, Daejeon (KR)

(72) Inventor: Kwang-Yong KIM, Daejeon-si (KR)

(21) Appl. No.: 14/450,442

(22) Filed: Aug. 4, 2014

(30) Foreign Application Priority Data
Dec. 18, 2013 (KR) 10-2013-0158616

(51) Int. Cl. H04N 7/18

(52) U.S. Cl. CPC H04N 7/181

(57) ABSTRACT

A system and method for automatically shifting tracking control authority between cameras, regardless of whether shooting ranges of cameras overlap, by allowing target object information to be shared between all IP cameras, receiving reports on a position of the target object from the respective IP cameras, comparing the received reports on a position of the target object, selecting an IP camera which provides a report of the nearest position of the target object to a center of a shooting range of the IP camera, and assigning tracking control authority to the selected IP camera.

### CROSS-REFERENCE TO RELATED APPLICATION(S)

This application claims the benefit under 35 U.S.C. §119(a) of Korean Patent Application No. 10-2013-0158616, filed on Dec. 18, 2013, in the Korean Intellectual Property Office, the entire disclosure of which is incorporated herein by references for all purposes.

### BACKGROUND

1. Field

The following description relates to a target object tracking technology using a camera, and more particularly, to an apparatus and method for automatically shifting tracking control authority between cameras.

2. Description of the Related Art

In the fields of security surveillance and broadcasts, a technology of tracking an object using image processing has been actively studied. Existing security surveillance systems using multiple cameras operate independently. Thus, it is difficult to continuously track a target when the target moves from a shooting range of a camera to that of a different camera.

To solve this drawback, a method for automatically shifting tracking control authority of a camera according to a moving direction of an object is proposed, as proposed in the “Real Time Object Tracking Method Using Multiple Cameras,” the Korea industrial information systems society 17 Vol. No. 4, 51-58.

However, the above-mentioned method also has drawbacks. That is, an object is determined simply based on color information thereof, so, if there is some noise in the color information, the object may be recognized as a different object. In addition, cameras have to be arranged with overlapping shooting ranges, as illustrated in FIG. 1.

Under this background, the inventor of the present disclosure started to investigate a technology that may reduce recognition errors which occur when an object is recognized only based on color information thereof, that may enable to tracking an object although shooting ranges of cameras do not overlap, and that may make it possible to track even multiple targets.

### SUMMARY

The objective of the present disclosure is providing a system and method for automatically shifting tracking control authority between cameras regardless of whether shooting ranges of cameras overlap, by allowing at least one target object information obtained from each IP cameras to be shared with multiple IP cameras, receiving reports on a target object's position shared by the respective IP cameras, comparing the received reports on a position of the target object, selecting an IP camera which provides a report of the nearest position of the target object to a center of a shooting range of the IP camera based on video properties information acquired from the respective IP cameras, and assigning tracking control authority to the selected IP camera.

In one general aspect, there is provided a system for automatically shifting tracking control authority between cameras, the system comprising a tracking control authority manager configured to: share at least one target object information obtained from each of IP cameras with an entire collection of the IP cameras; receive reports on a position of a shared target object from the respective IP cameras, select an IP camera which provides a report of the nearest position of the shared target object to a center of a shooting range of the IP camera based on video properties information acquired from the respective IP cameras; and assign tracking control authority to the selected IP camera.

The system may further comprise the IP cameras, each of which is configured to transmit video properties information of its own and the at least one target object information to the tracking control authority manager over a network.

The each of the IP cameras may be configured to comprise a video properties information acquirer configured to acquire video properties information that includes a shooting range of itself and a center of the shooting range; an object multi-feature vector generator configured to detect the target object and to generate color information, centroid-of-contour information and moving direction information of the target object; an object identification (ID) generator configured to generate an identification (ID) of the target object; and a communicator configured to transmit, to the tracking control authority manager, the video properties information of itself and target object information that contains the ID and multi-feature vector of the target object.

The each of the IP cameras is further configured to comprise a shared information storage configured to store target object information containing an ID and a multi-feature vector of at least one target object shared by the tracking control authority manager.

The each of the IP cameras may be further configured to comprise a target object position tracker configured to track a centroid of contour of a target object existing in a shooting range of itself based on target object information stored in the shared information storage, and to report the found centroid of contour of the target object to the tracking control authority manager.

The each of the IP cameras may be further configured to comprise a shooting controller configured to, in response to being assigned with tracking control authority for a specific target object by the tracking control authority manager, perform control of shooting the specific target object.

The object multi-feature vector generator may be configured to extract an object area with a same color from frame images shoot by the selected IP camera by comparing differential images between a reference image and the frame images; thin contour of the extracted object area from outside thereof; and extract the object area as a target object when a change in a centroid of the contour is detected and a constant moving direction is maintained for a predetermined number of frames.

The tracking control authority manager may be configured to comprise a multicast communicator configured to receive video properties information and at least one target object information from of the respective IP cameras; a target object information manager configured to manages a database configured to store the properties information and the at least one target object information, and to multicast the video properties information and the at least target object information to the each of the IP cameras to allow the at least one target object information to be shared between all the IP cameras; and a tracker camera inferrer configured to receive reports on a position of a shared target object from the respective IP cameras, select an IP camera which provides a report of the nearest position of the target object to a center of a shooting range of the IP camera, and assign tracking control authority to the selected IP camera.

The tracker camera inferrer may be further configured to compare a center of a shooting range of each of the IP cameras to a centroid of contour of the target object, the center of the shooting range being included in video properties information of each of the IP cameras and the centroid of contour of the target object being reported by each of the IP cameras., and to select an IP camera which provides a report of the nearest centroid of contour of the target object to a center of a shooting range of the IP camera.

In another general aspect, there is provided a method for automatically shifting tracking control authority between cameras in a system for automatically shifting tracking control authority between cameras, wherein the system comprises IP cameras and a tracking control authority manager that works in association with each of the IP cameras, the method performed by the tracking control authority manager and comprising: receiving, from each of the IP cameras, video properties information of itself and at least one target object information; storing the video properties information and the at least one target object information in a database; transmitting the at least one target object information to each of the IP cameras to allow the IP cameras to share the at least one target object information; receiving reports on a position of a shared target object from the respective IP cameras; selecting an IP camera which provides a report of the nearest position of the target object to a center of a shooting range of the IP camera; and assigning tracking control authority to the selected IP camera.

The selecting of an IP camera comprises comparing a center of a shooting range of each of the IP cameras to a centroid of contour of the target object, the center of the shooting range being included in video properties information of each of the IP cameras, and the centroid of contour of the target object being reported by each of the IP cameras; and selecting an IP camera which provides a report of the nearest position of the target object to a center of a shooting range of the IP camera.

Other features and aspects may be apparent from the following detailed description, the drawings, and the claims.

### BRIEF DESCRIPTION OF THE DRAWINGS

FIG. 1 is a diagram illustrating an example in which conventional cameras are set up with overlapping shooting ranges when tracking a target object;

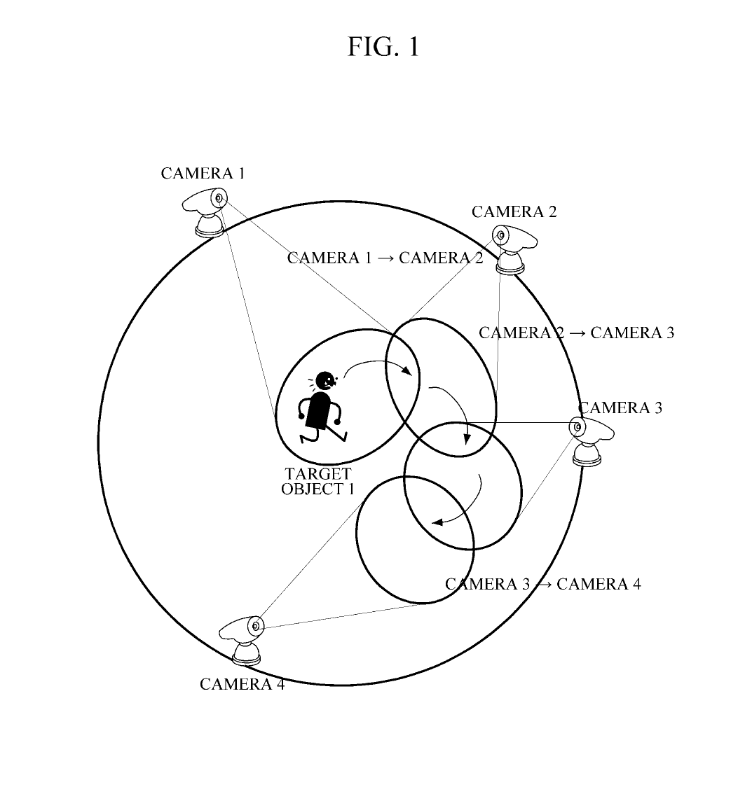

FIG. 2 is a diagram illustrating an example of a system for automatically shifting tracking control authority between cameras, the system where cameras are set up without overlapping shooting range, according to an exemplary embodiment;

FIG. 3 is a block diagram illustrating a configuration of a system for automatically shifting tracking control authority between cameras according to an exemplary embodiment; and

FIG. 4 is a flow chart illustrating an example of a method for automatically shifting tracking control authority between cameras according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, in describing the present disclosure, detailed descriptions of relevant functions or structures well-known to those skilled in the art will be omitted when it is considered that the descriptions obscure the point of the present invention.

In addition, terms used hereinafter are defined by taking into consideration functions thereof in exemplary embodiments of the present disclosure. The terms may be changed according to intention or practices of a user or operator. Thus, each of the terms should be defined based on descriptions set forth herein.

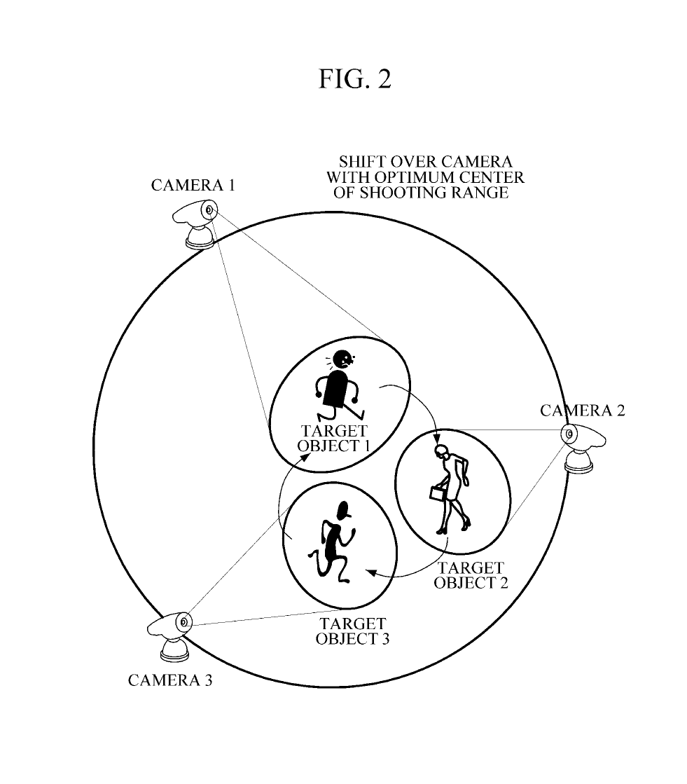

A system for automatically shifting tracking control authority between cameras according to an exemplary embodiment is able to track a target object regardless of whether shooting ranges of cameras overlap. FIG. 2 demonstrates an example of a system for automatically shifting tracking control between cameras, the system where cameras are set up without overlapping shooting ranges. As illustrated in FIG. 2, a plurality of IP cameras may be set up in the system without any overlapping shooting range.

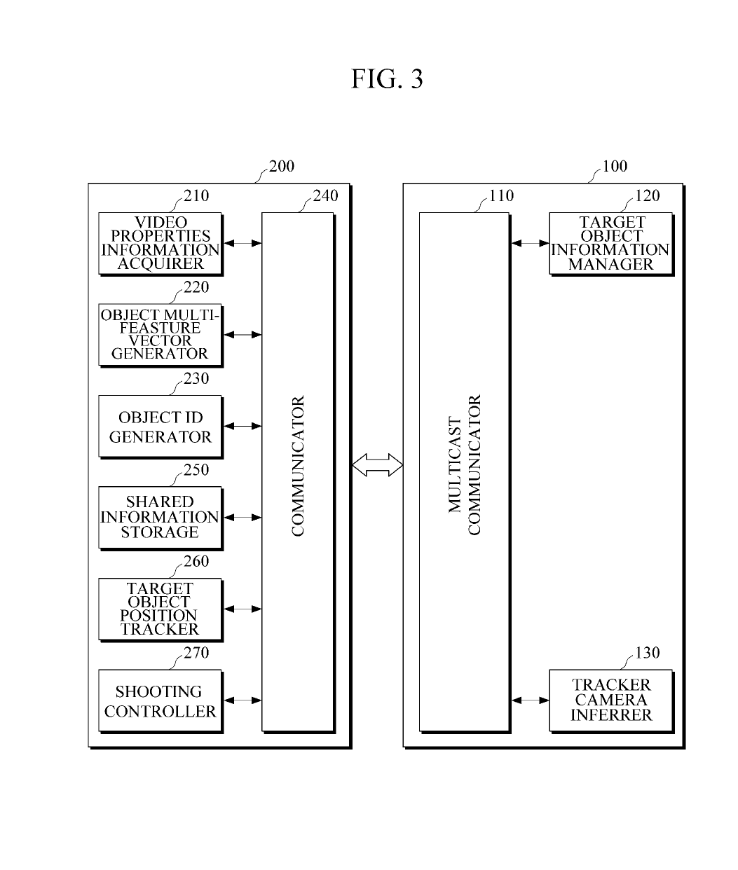

FIG. 3 is a block diagram illustrating an example of a configuration of a system for automatically shifting tracking control between cameras according to an exemplary embodiment. As illustrated in FIG. 3, the system includes a tracking control manager and a plurality of IP cameras 200.

The tracking control manager 100 shares at least one target object information, which is acquired from each of IP cameras over a network, with the entire collection of IP cameras, receives reports of a position of a shared target object from the respective IP cameras, selects an IP camera which provides a report of the nearest position of the shared target object to the IP camera based on video properties acquired from the respective IP cameras, and assigns tracking control authority to the selected IP camera.

The IP cameras 200 are set up regardless of whether shooting ranges thereof overlap. Each of the IP cameras 200 provides video properties information of its own and at least one target object information to the tracking control manager 100 over a network.

At this point, the video properties information obtained from a corresponding IP camera 200 may include a shooting range of the corresponding IP camera 200 and a center of the shooting range. Target object information may include an identification (ID) and a multi-feature vector of a target object. The multi-feature vector may include color information, centroid-of-contour information and moving direction information of a target object.

That is, the present disclosure is able to track a target object regardless of whether shooting ranges of IP cameras overlap, by allowing target object information to be shared between all the IP cameras, receiving reports on a position of the target object from of the respective IP cameras, comparing all the received reports on a position of the target object, selecting an IP camera which provides a report of the nearest position of the target object to a center of a shooting range of the IP camera, and assigning tracking control authority to the selected IP camera.

According to an additional aspect of the present disclosure, each of the IP cameras 200 may include a video properties acquirer 210, an object multi-feature vector generator 220, an object ID generator 230 and a communicator 240. The video properties information acquirer 210 acquires video properties information that includes a shooting range of a corresponding IP camera and a center of the shooting range. For example, the video properties information acquirer 210 may calculate a center of an image shoot by the corresponding IP camera, and may calculate a shooting range of the corresponding IP camera. A centroid of contour in the shooting range is the calculated center. In addition, the shooting range is a particular rectangular area.

The object multi-feature vector generator 220 detects a target object, and generates a multi-feature vector that includes color information, centroid-of-contour information and moving direction information of the target object.

For example, the object multi-feature vector generator 220 compares difference images between a reference background image having no object and an image with the current frame shoot by a camera, extracts at least one object area with the same color from each extracted difference image, and thins the contour of the object area from the outside thereof. Then, when a change in a centroid of the object area is detected while the object area constantly moves in the same direction for a predetermined number of frames, the object area may be determined as a target object.

The object ID generator 230 generates an identification (ID) of the target object. The ID of the target object may be distinct information that is generated to identify the target object, and may be a series of random numbers and/or characters that are differently arranged from an ID of other target objects.

The communicator 240 transmits to the tracking control authority manager 100 the video properties information and the target object information that includes an ID and a multi-feature vector of the target object.

In this embodiment, the tracking control authority manager 100 may acquire video properties information of each IP camera and at least one target object information in such a manner that each of IP cameras provides the tracking control authority manager 100 over a network with video properties information of a corresponding IP camera and target object information on at least one target object which exists in a shooting range of the corresponding IP camera.

According to an additional aspect of the present disclosure, each of IP cameras 200 may further include a shared information storage 250. The shared information storage 250 stores target object information shared by the tracking control authority manager 100, the target object information which includes an ID and a multi-feature vector of at least one shared target object.

The ID and the multi-feature vector, which are stored in the shared information storage 250, are used in tracking a position of the target object.

According to an additional aspect of the present disclosure, each of IP cameras 200 may further include a target object position tracker 260. The target object position tracker 260 tracks a centroid of contour of a target object existing in a shooting range of a corresponding IP camera 200 based on the target object information stored in the shared information storage 250, and then reports the found centroid of contour of the object to the tracking control authority manager 100.

A center of centroid of the target object may be obtained by thinning contour of the target object from the outside thereof. The tracking control authority manager 100 receives reports on a position of the target object from the IP cameras 200, selects an IP camera which provides a report of the nearest center of centroid of the target object to a center of a shooting range of the IP camera based on video properties information acquired from the respective IP cameras, and then assigns tracking control authority to the selected IP camera.

According to an additional aspect of the present disclosure, each of the IP cameras 200 may further include a shooting controller 270. In the case where an IP camera 200 is assigned with tracking control authority for a specific target object by the tracking control authority manager 100, the shooting controller 270 of the IP camera 200 performs control of shooting the target object.

At this point, if a previous IP camera assigned with tracking control authority is turned out to be identical to a new IP camera assigned with the tracking control authority, the tracking control authority is maintained in the same IP camera. Alternatively, if a previous IP camera assigned with tracking control authority is turned out to be different from a new IP camera assigned with the target object tracking control authority, the target object tracking control authority is shifted from the previous IP camera to the new IP camera.

Accordingly, in this embodiment, the present disclosure may track a target object regardless of whether shooting ranges of IP cameras overlap, by allowing target object information to be shared between all the IP cameras, receiving reports on a position of the target object from the respective IP cameras, comparing all the received reports on a position of the target object, selecting an IP camera which provides a report of the nearest position of the target object to a center of a shooting range of the IP camera, and assigning tracking control authority to the selected IP camera.

According to an additional aspect of the present disclosure, the tracking control authority manager 100 may include a multicast communicator 110, a target object information manager 120 and a tracker camera inferrer 130.

The multicast communicator 110 receives video properties information and target object information from each of IP cameras 200. Video properties information may include a shooting range of a corresponding IP camera 200 and a center of the shooting range. Target object information may include an ID and a multi-feature vector of a target object. A multi-feature vector may include color information, centroid-of-contour information and moving direction information of the target object.

For management, the target object information manager 120 stores video properties information and target object information in database (DB). Then, the target object information manager 120 multicasts at least one target object information, obtained from each of the IP cameras 200, to the entire collection of IP cameras 200, so that at least one target object information is shared between all the IP cameras 200. Then, each of the IP cameras 200 tracks a position of the target object, and provides a report on the found position of the target object to the tracking control authority manager 100.

The tracker camera inferrer 130 receives reports on a position of the target object from each of the IP cameras 200, selects an IP camera which provides a report of the nearest position of the target object to a center of a shooting range of the IP camera based on video properties information acquired from the respective IP cameras, and assigns tracking control authority to the selected IP camera.

In this case, the tracker camera inferrer 130 compares a center of a shooting range of each of the IP cameras 200, which is included in video properties information of each of the IP cameras 200, to a centroid of contour of the target object, which is reported by each of the IP cameras 200. Then, the tracker camera inferrer 130 selects a specific IP camera to be assigned with target object tracking control authority, the specific IP camera which provides a report of the nearest centroid of contour of the target object to a center of a shooting range of the specific IP camera.

Accordingly, in this embodiment, the present disclosure is able to track a target object regardless of whether shooting ranges of IP cameras overlap, by allowing target object information to be shared between all the IP cameras, receiving reports on a position of the target object from each of the IP cameras, comparing all the received reports on a position of the target object, selecting an IP camera which provides a report of the nearest position of the target object to a center of a shooting range of the IP camera, and assigning tracking control authority to the selected IP camera.

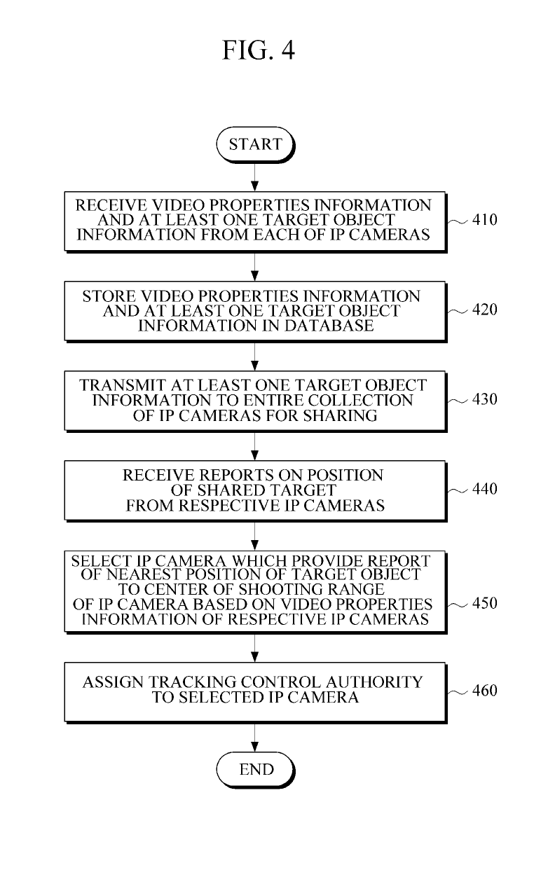

Hereinafter, a procedure of automatically shifting tracking control authority between cameras in the above-described system for shifting tracking control authority between cameras is described with reference to FIG. 4. FIG. 4 is a flow chart illustrating an example of a method for automatically shifting tracking control authority between cameras in a system for automatically shifting tracking control authority between cameras according to an exemplary embodiment.

When each of IP cameras transmits video properties information of its own and at least one target object information, a tracking control authority manager receives the video properties information and at least one target object information from each of the IP cameras in operation 410.

Then, in operation 420, the tracking control authority manager stores the video properties information and at least one target object information in a database.

Then, in operation 430, the tracking control authority manager transmits to all the IP cameras at least one target object information stored in operation 420 so that at least one target object information is shared between all the IP cameras.

Each IP camera, which is sharing at least one target object information, tracks a position of a target object existing in a shooting range thereof, and provides a report on the found position of the target object to the tracking control authority manager. In response, in operation 440, the tracking control authority manager receives the reports on the found position of the target object.

In operation 450, the tracking control authority manager selects an IP which provides a report of the nearest position of the target object to a center of a shooting range of a corresponding IP camera based on video properties information that is stored in operation 420.

At this point, in operation 450, the tracking control authority manager may compare a center of a shooting range of each of the IP cameras, which is included in video properties information of itself, to centroids of contour of the target object, which are reported by the respective IP cameras. Then, the tracking control authority manager may select an IP camera to be assigned with tracking control authority, the IP camera which provides a report of the nearest centroid of contour of the target object to a center of a shooting range of the IP camera.

Then, in operation 460, the tracking control authority manager assigns the selected IP camera with the tracking control authority. The IP camera assigned with the tracking control authority performs control of shooting the target object.

At this point, if a previous IP camera assigned with tracking control authority is turned out to be identical to a new IP camera assigned with the tracking control authority, the tracking control authority is maintained in the same IP camera. Alternatively, if a previous IP camera assigned with the tracking control authority is turned out to be different from a new IP camera assigned with the tracking control authority, the tracking control authority is shifted from the previous IP camera to the new IP camera.

Accordingly, in this embodiment, the present disclosure is able to track a target object regardless of whether shooting ranges of IP cameras overlap, by allowing target object information to be shared between all the IP cameras, receiving reports on a position of the target object from the respective IP cameras, comparing all the received reports on a position of the target object, selecting an IP camera which provides a report of the nearest position of the target object to a center of a shooting range of the IP camera, and assigning tracking control authority to the selected IP camera.

Meanwhile, as the present disclosure recognizes and tracks a target object based on color information, centroid-of-contour information and moving direction information of the target object, it is possible to reduce recognition errors that color noise may cause in the case where recognition of an object is performed simply based on color information thereof.

In addition, the present disclosure may track multiple target objects, and may be utilized not only in a security surveillance field, but also in a broadcasting field as various application systems in which a user may select and watch an object of interest at a desired angle.

Those who are skilled in the related art may understand that various and specific modifications may be made without modifying the technical ideas or essential characteristics of the invention. Accordingly, the embodiments disclosed above are exemplary, and should be understandable not to be limited to in all aspects.

What is claimed is:

1. A system for automatically shifting tracking control authority between cameras, the system comprising a tracking control authority manager configured to:
share at least one target object information obtained from each of IP cameras with an entire collection of IP cameras;
receive reports on a position of a shared target object from the respective IP cameras,
select an IP camera which provides a report of the nearest position of the shared target object to a center of a shooting range of the IP camera based on video properties information acquired from the respective IP cameras; and
assign tracking control authority to the selected IP camera.

2. The system of claim 1, further comprising:
the IP cameras, each of which is configured to transmit video properties information of its own and the at least one target object information to the tracking control authority manager over a network.

3. The system of claim 1, wherein the each of the IP cameras is configured to comprise:
a video properties information acquirer configured to acquire video properties information that includes a shooting range of itself and a center of the shooting range;
an object multi-feature vector generator configured to detect the target object and to generate color information, centroid-of-contour information and moving direction information of the target object;
an object identification (ID) generator configured to generate an identification (ID) of the target object; and
a communicator configured to transmit, to the tracking control authority manager, the video properties information of itself and target object information that contains the ID and multi-feature vector of the target object.

4. The system of claim 3, wherein the each of the IP cameras is further configured to comprise:
a shared information storage configured to store target object information containing an ID and a multi-feature vector of at least one target object shared by the tracking control authority manager.

5. The system of claim 4, wherein the each of the IP cameras is further configured to comprise:
a target object position tracker configured to track a centroid of contour of a target object existing in a shooting range of itself based on target object information stored in the shared information storage, and to report the found centroid of contour of the target object to the tracking control authority manager.

6. The system of claim 3, wherein the each of the IP cameras is further configured to comprise:
a shooting controller configured to, in response to being assigned with tracking control authority for a specific target object by the tracking control authority manager, perform control of shooting the specific target object.

7. The system of claim 3, wherein the object multi-feature vector generator is configured to:
extract an object area with a same color from frame images shoot by the selected IP camera by comparing differential images between a reference image and the frame images;
thin contour of the extracted object area from outside thereof; and
extract the object area as a target object when a change in a centroid of the contour is detected and a constant moving direction is maintained for a predetermined number of frames.

8. The system of claim 3, wherein the tracking control authority manager is configured to comprise:
a multicast communicator configured to receive video properties information and at least one target object information from of the respective IP cameras;
a target object information manager configured to manages a database configured to store the properties information and the at least one target object information, and to multicast the video properties information and the at least target object information to the each of the IP cameras to allow the at least one target object information to be shared between all the IP cameras; and
a tracker camera inferrer configured to receive reports on a position of a shared target object from the respective IP cameras, select an IP camera which provides a report of the nearest position of the target object to a center of a shooting range of the IP camera, and assign tracking control authority to the selected IP camera.

9. The system of claim 8, wherein the tracker camera inferrer is further configured to
compare a center of a shooting range of each of the IP cameras to a centroid of contour of the target object, the center of the shooting range being included in video properties information of each of the IP cameras, and the centroid of contour of the target object being reported by each of the IP cameras, and
select an IP camera which provides a report of the nearest centroid of contour of the target object to a center of a shooting range of the IP camera.

10. A method for automatically shifting tracking control authority between cameras in a system for automatically shifting tracking control authority between cameras, wherein the system comprises IP cameras and a tracking control authority manager that works in association with each of the IP cameras, the method performed by the tracking control authority manager and comprising:
receiving, from each of the IP cameras, video properties information of itself and at least one target object information;
storing the video properties information and the at least one target object information in a database;
transmitting the at least one target object information to each of the IP cameras to allow the IP cameras to share the at least one target object information;
receiving reports on a position of a shared target object from the respective IP cameras;
selecting an IP camera which provides a report of the nearest position of the target object to a center of a shooting range of the IP camera; and
assigning tracking control authority to the selected IP camera.

11. The method of claim 10, wherein the selecting of an IP camera comprises:
comparing a center of a shooting range of each of the IP cameras to a centroid of contour of the target object, the center of the shooting range being included in video properties information of each of the IP cameras, and the centroid of contour of the target object being reported by each of the IP cameras; and
selecting an IP camera which provides a report of the nearest position of the target object to a center of a shooting range of the IP camera.
